(19) United States
(12) Patent Application Publication
(10) Pub. No.: US 2026/0172384 A1
(43) Pub. Date: Jun. 18, 2026

(54) SYSTEMS AND METHODS FOR AI-BASED ELECTRONIC MAIL MANAGEMENT

(71) Applicant: YAHOO ASSETS LLC, New York, NY (US)

(72) Inventors: Umang PATEL, Sunnyvale, CA (US); Rofaida ABDELAAL, Sunnyvale, CA (US); Tejas THVAR, Los Altos, CA (US); Bhopal SINGH, San Jose, CA (US); Aditya BANDI, San Mateo, CA (US)

(21) Appl. No.: 18/981,785

(22) Filed: Dec. 16, 2024

(51) Int. Cl. H04L 51/42; H04L 51/214; H04L 51/226

(52) U.S. Cl. CPC H04L 51/42; H04L 51/214; H04L 51/226

(57) ABSTRACT

Disclosed are systems and methods that provide a scalable, decision intelligence (DI)-based computerized framework for electronic mail delivery and management within an electronic mail platform. The disclosed framework utilizes advanced AI/ML techniques to dynamically classify and route electronic messages. The framework leverages deep learning models to predict user engagement probabilities, analyzing multidimensional signals including user behavior, content semantics, and interaction patterns. By implementing a sophisticated dual-model architecture with centralized and on-device processing, the framework enables personalized inbox management. The framework continuously learns and adapts through iterative model training, enabling the curation of custom priority rules and tabs while maintaining high-precision message routing based on predicted user interactions.

### FIELD OF THE DISCLOSURE

The present disclosure relates to electronic messaging, and more particularly, to a scalable, decision intelligence (DI)-based computerized framework for managing messages within an inbox for a user in a contextual and/or personalized, artificial intelligence (AI) based manner.

### SUMMARY OF THE DISCLOSURE

According to some embodiments, the disclosed systems and methods provide a computerized framework for performing personalized electronic mail (“email”) priority classification and delivery within an associated inbox of a user's email account. The disclosed framework addresses the critical challenge of email inbox organization through a novel personalization approach that dynamically classifies and prioritizes email messages with unprecedented granularity and user-specific precision. The framework introduces a number of key technological innovations that fundamentally transform email inbox management through advanced machine learning and personalization techniques.

In some embodiments, a first innovation centers on User Action Predictions, which leverages a sophisticated deep learning model to predict individual user behaviors with remarkable accuracy. Such model and corresponding operations, as discussed herein, can function to generate probabilistic assessments of a user's likelihood to open or delete specific messages by analyzing historical user interactions, content-based features, and frequently engaged communication patterns. By introducing a predictive layer, the framework transcends traditional static email categorization, enabling a dynamic and adaptive prioritization mechanism that evolves with user behavior.

In some embodiments, another technological component of the disclosed framework focuses on Explicit User Overrides, which provides users granular control over their inbox segmentation. As discussed herein, such mechanisms introduce three sophisticated override mechanisms: sender-based, content-based, and combined sender-content overrides. Users can explicitly define priority criteria, allowing the framework to learn and automatically apply personalized classification rules. Such feature addresses the inherent subjectivity of email importance by empowering users to directly influence their inbox organization.

In some embodiments, another innovation provided by the disclosed framework involves Learning from Explicit and Implicit User Signals, which integrates a lightweight machine learning (ML) model distilled from a large language model (LLM). As discussed herein, such ML model can function to ingest a comprehensive range of user signals, categorized into implicit and explicit features. Implicit features encompass sophisticated dimensions such as content embeddings, behavioral engagement metrics, demographic characteristics, contextual information, user cohort similarities, and the like. Explicit features include thread interaction patterns, email action frequencies, user-generated feedback, and custom tab configurations. By synthesizing these multidimensional signals, the framework creates a nuanced, personalized understanding of email priority.

In some embodiments, the framework further provides functionality Tab Customization, thereby allowing users to define and configure their inbox taxonomy dynamically. Such feature enables users to create custom content categories that reflect their individual communication preferences and information consumption patterns. By providing this level of granular customization, the framework transforms email organization from a generic, one-size-fits-all approach to a highly personalized experience that adapts to each user's unique communication ecosystem.

In some embodiments, the framework further provides capabilities for On-Device Personalization via a dual-model approach that balances centralized server-side processing with localized, device-specific refinement. As discussed herein, in some embodiments, a high-level centralized model can initially score (quantify) emails, with promising candidates (e.g., scores at or above a threshold) then processed by a per-user on-device model. This approach offers multiple advantages, inter alia: enhanced prediction accuracy, reduced latency, improved user privacy through minimal data transmission, and the ability to capture both short-term and historical user engagement patterns.

Accordingly, as discussed herein, in some embodiments, framework's technological contributions extend beyond traditional email classification methodologies. By addressing the “Priority Inbox FOMO” (fear of missing out) challenge, it ensures comprehensive email coverage while minimizing the risk of overlooking critical communications.

The disclosed mechanisms acknowledge and systematically address the fundamental subjectivity inherent in email importance classification. That is, for example, the framework can function to perform a comparative analysis with alternative implementations-such as heuristics-only approaches or generalized deep learning classifiers-that demonstrate the framework's novel capabilities.

While alternative conventional methods may offer generalized classification, they fundamentally fail to capture the nuanced, individual-specific dimensions of email priority. The disclosed framework's personalization layer introduces a transformative dimension, factoring in 1:1 user preferences and historical behaviors to significantly enhance priority identification recall and coverage.

Moreover, from a technical perspective, the framework's AI/ML architecture offers several key advantages. For example, the framework captures complex, non-linear communication patterns through advanced deep learning techniques while maintaining high generalizability. And, the multi-modal signal integration allows for sophisticated feature engineering that goes beyond traditional content-based or behavioral classification strategies.

Accordingly, as provided herein, the disclosed framework's technological innovations provide a significant leap in email management technology, transitioning from static, rule-based categorization to a dynamic, learning-driven personalization framework. By empowering users with unprecedented control and leveraging advanced machine learning techniques, the disclosed mechanisms can revolutionize how individuals interact with and manage their digital communication ecosystems.

According to some embodiments, a method is disclosed for a DI-based computerized framework for electronic mail delivery and management within an electronic mail platform. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for electronic mail delivery and management within an electronic mail platform.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub- networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

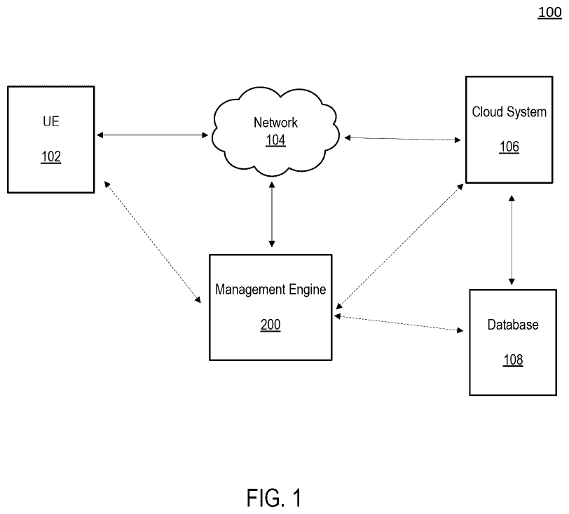

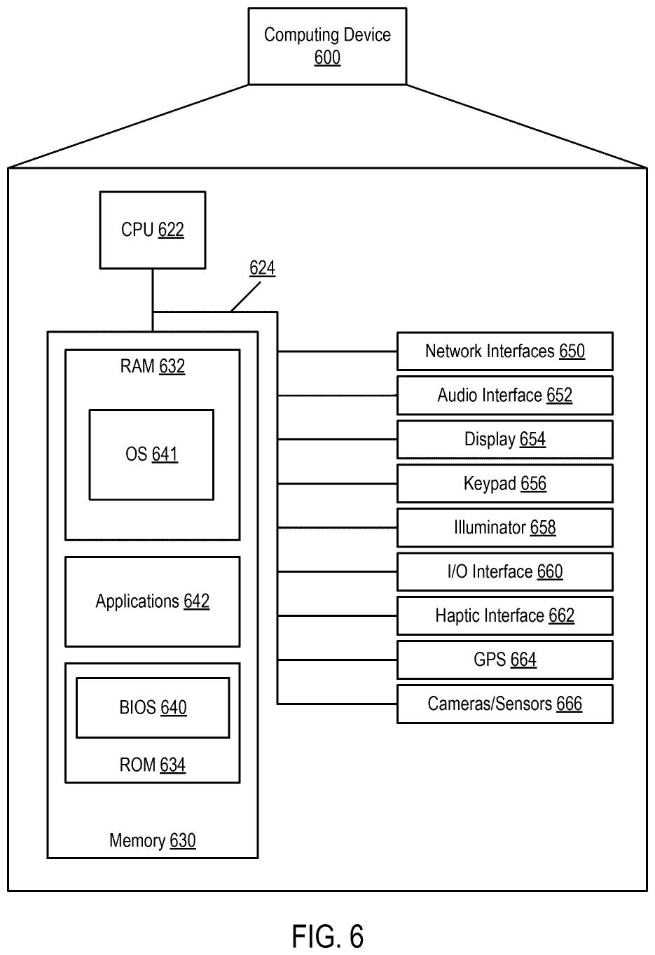

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), network 104, cloud system 106, database 108, and management engine 200. It should be understood that while system 100 is depicted as including such components, it should not be construed as limiting, as one of ordinary skill in the art would readily understand that varying numbers of UEs, peripheral devices, cloud systems, databases, network resources, engines and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, Internet of Things (IoT) device, autonomous machine, and any other device equipped with a cellular or wireless or wired transceiver.

In some embodiments, a peripheral device (not shown) can be connected to UE 102, and can be any type of peripheral device, such as, but not limited to, a wearable device (e.g., smart watch), printer, speaker, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a network and/or electronic mail platform (e.g., Yahoo! Mail®, for example), which has associated network resources hosted on the internet or private network (e.g., network 104), which enables (via engine 200) the tagging and search functionality and capabilities discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE, and the services and applications provided by cloud system 106 and/or management engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

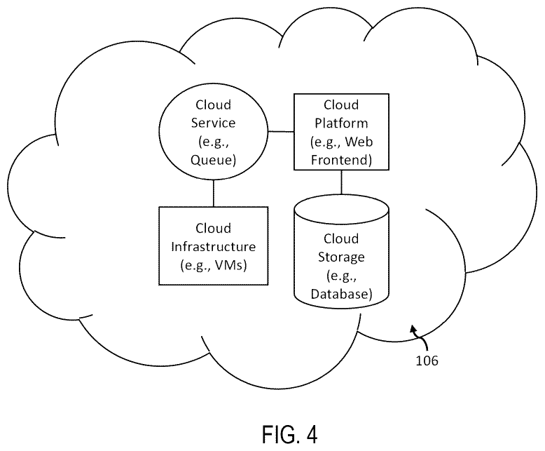

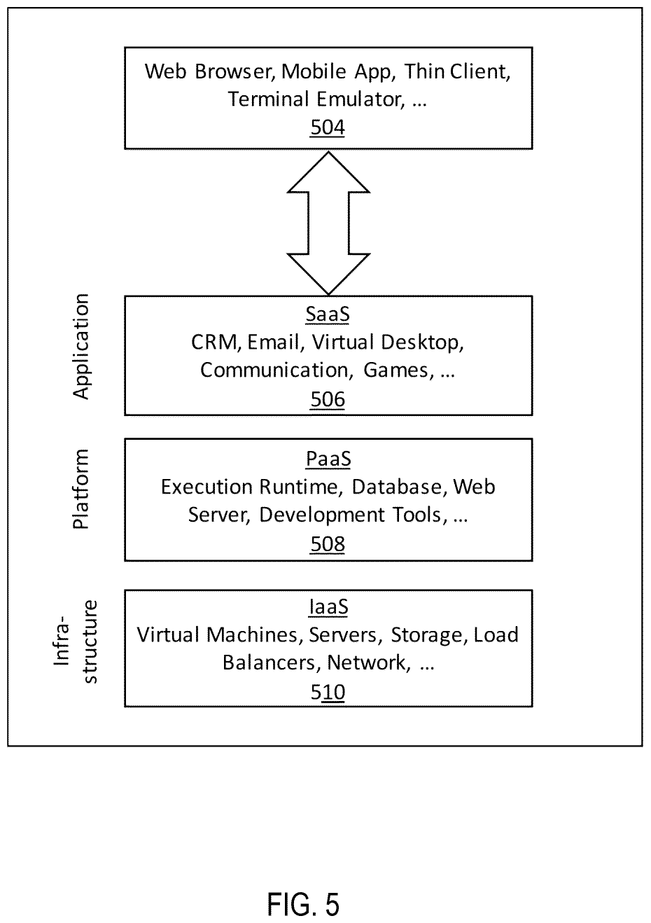

Turning to FIG. 4 and FIG. 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIG. 4 and FIG. 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, standard query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Management engine 200, as discussed above and further below in more detail, can include components for the disclosed functionality. According to some embodiments, management engine 200 may be a special purpose machine or processor, and can be hosted by a device on network 104, within cloud system 106, and/or on UE 102. In some embodiments, engine 200 may be hosted by a server and/or set of servers associated with cloud system 106.

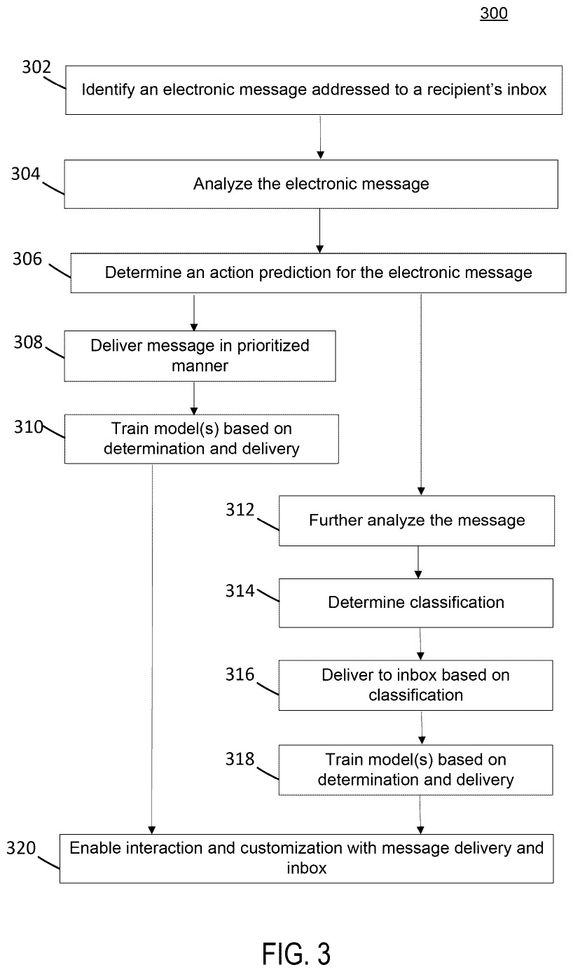

According to some embodiments, as discussed in more detail below, management engine 200 may be configured to implement and/or control a plurality of services and/or microservices, where each of the plurality of services/microservices are configured to execute a plurality of workflows associated with performing the disclosed search functionality. Non-limiting embodiments of such workflows are provided below in relation to at least FIG. 3.

According to some embodiments, as discussed above, management engine 200 may function as an application provided by cloud system 106. In some embodiments, engine 200 may function as an application installed on a server(s), network location and/or other type of network resource associated with system 106. In some embodiments, engine 200 may function as an application installed and/or executing on UE 102. In some embodiments, such application may be a web-based application accessed by UE 102 over network 104 from cloud system 106. In some embodiments, engine 200 may be configured and/or installed as an augmenting script, program or application (e.g., a plug-in or extension) to another application or program provided by cloud system 106 and/or executing on UE 102.

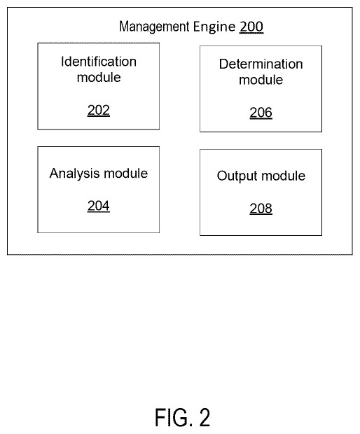

As illustrated in FIG. 2, according to some embodiments, management engine 200 includes identification module 202, analysis module 204, determination module 206 and output module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below. Management engine 200 or other device(s) running Process 300 may be operated entirely at the user device level, or with cloud support as a distributed system, or at a mail service provider's infrastructure, as non-limiting implementation examples. It will be understood that the disclosure herein provides for a configuration that is platform agnostic and may be operated on multiple alternative platforms as a matter of design choice using the teachings described.

Turning to FIG. 3, Process 300 provides non-limiting example embodiments for a DI-based computerized framework for electronic mail delivery and management within an electronic mail platform. As provided below, the disclosed framework's configuration and implementation can provide a computerized suite of tools for providing advancements in how electronic messages are handled pursuant to their display within a recipient's inbox, as well as how users can interact with such electronic messages.

According to some embodiments, Step 302 of Process 300 can be performed by identification module 202 of management engine 200; Steps 304 and 312 can be performed by analysis module 204; Steps 306 and 314 can be performed by determination module 206; and Steps 308, 310 and 316-320 can be performed by output module 208.

According to some embodiments, Process 300 begins with Step 302 where an electronic message addressed to an inbox of a user is identified. In some embodiments, Step 302 can involve identifying data points related to the message, which can include, but are not limited to, sender information (e.g., email address, domain, historical sender reputation, previously tagged categories associated with the sender, and the like), message metadata (e.g., timestamp of receipt, subject line, attachment presence, message size, and the like), recipient context (e.g., whether the message is addressed directly, as part of a group, or via carbon copy (CC), and the like), and the like, or some combination thereof. Thus, the identification process of Step 302 can ensure incoming messages are tagged and queued for analysis by downstream components, regardless of its potential classification.

As discussed above, engine 200 can operate on a UE (e.g., sender and/or recipient device) and/or on a device on the network; therefore, in some embodiments, the identification of the message can be performed upon receiving the message at the relaying server (e.g., message server on network 104), and/or at the recipient device (e.g., via engine 200 acting in accordance with an email client running on a recipient user's UE).

Thus, as discussed herein, the disclosed operational steps of Process 300 can be performed at the cloud/network level and/or at the user device level, without the need for cloud communication, as devices are now and in the future capable of running AI applications in whole or in part without the need for cloud support.

In Step 304, engine 200 can perform operations to analyze the electronic message. In some embodiments, engine 200 can parse and extract information from the message that can be utilized to determine an action prediction for the user, as discussed herein and in more detail below.

In some embodiments, the computational analysis performed in Step 304 can involve engine 200 calling and executing an AI, ML and/or LLM model. Accordingly, in some embodiments, the AI/ML models can be any type of known or to be known, specifically trained AI/ML model, particular machine learning model architecture, particular machine learning model type (e.g., convolutional neural network (CNN), recurrent neural network (RNN), autoencoder, support vector machine (SVM), and the like), or any other suitable definition of an AI/ML model or any suitable combination thereof.

In some embodiments, an LLM can be leveraged, as discussed herein, whether known or to be known. As discussed above, an LLM is a type of AI system designed to understand and generate human-like text based on the input it receives. The LLM can implement technology that involves deep learning, training data and natural language processing (NLP). Large language models are built using deep learning techniques, specifically using a type of neural network called a transformer. These networks have many layers and millions or even billions of parameters. LLMs can be trained on vast amounts of text data from the internet, books, articles, and other sources to learn grammar, facts, and reasoning abilities. The training data helps them understand context and language patterns. LLMs can use NLP techniques to process and understand text. This includes tasks like tokenization, part-of-speech tagging, and named entity recognition.

LLMs can include functionality related to, but not limited to, text generation, language translation, text summarization, question answering, conversational AI, text classification, language understanding, content generation, and the like. Accordingly, LLMs can generate, comprehend, analyze and output human-like outputs (e.g., text, speech, audio, video, and the like) based on a given input, prompt or context. Accordingly, LLMs, which can be characterized as transformer-based LLMs, involve deep learning architectures that utilizes self-attention mechanisms and massive-scale pre-training on input data to achieve NLP understanding and generation. Such current and to-be-developed models can aid AI systems in handling human language and human interactions therefrom.

In some embodiments, such model can be configured to identify and utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique can be one of, without limitation, feedforward neural network, radial basis function network, recurrent neural network, convolutional network (e.g., U-net) or other suitable network. In some embodiments and, optionally, in combination of any embodiment described above or below, an implementation of Neural Network can be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model can specify a neural network by at least a neural network topology, a series of activation functions, and connection weights. For example, the topology of a neural network can include a configuration of nodes of the neural network and connections between such nodes. In some embodiments and, optionally, in combination of any embodiment described above or below, the trained neural network model can also be specified to include other parameters, including but not limited to, bias values/functions and/or aggregation functions. For example, an activation function of a node can be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function can be a mathematical function that combines (e.g., sum, product, and the like) input signals to the node. In some embodiments and, optionally, in combination of any embodiment described above or below, an output of the aggregation function can be used as input to the activation function. In some embodiments and, optionally, in combination of any embodiment described above or below, the bias can be a constant value or function that can be used by the aggregation function and/or the activation function to make the node more or less likely to be activated.

For example, in some embodiments, via the AI/ML and/or LLM processing, engine 200 can perform content processing via NLP techniques applied to the subject line, body content and attachments, and the like. Such processing can identify key features within the message, such as, for example, sentiment, urgency (e.g., use of phrases like “action required”, for example), topic relevance, and the like.

In some embodiments, via the AI/ML and/or LLM processing, engine 200 can perform behavior correlations with the recipient user. For example, engine 200 can correlate message features with the recipient's historical behavior, such as, for example, patterns of opening or ignoring emails with similar content.

In some embodiments, such analysis can be based on engagement metrics (e.g., click-through rates on previous messages from the sender, and/or of a similar type of the incoming message from Step 302, for example).

And, which can be performed in combination with the above processing, in some embodiments, via the AI/ML and/or LLM processing, engine 200 can perform contextual analysis based on information related to, but not limited to, time, date, device type, recipient and/or sender demographics and/or geographics, and the like, or some combination thereof.

Accordingly, based on the AI/ML and/or LLM based analysis in Step 308, engine 200 can determine an action prediction for the electronic message. That is, in some embodiments, engine 200 can score the messages (e.g., on a scale, for example, 1-100) and determine the likelihood that the user will engage with the message (e.g., if the score satisfies a threshold value). Engine 200 can employ, for example, historical data and user-specific behavior patterns to generate the prediction score, which represents the probability of the user performing actions such as opening, replying, forwarding, or deleting the email.

According to some embodiments, the determination (e.g., prediction process) incorporates advanced feature engineering by weighting engagement predictors including, but not limited to, sender interaction history, sophisticated content embeddings, comprehensive user demographic information, and the like. Behavioral metrics can play a crucial role, with engine 200 analyzing critical indicators like user dwell time on similar messages and prior engagement patterns with specific senders. Each message receives sophisticated metadata tagging that reflects its priority score and predicted user action, such as “90% likelihood to open” or “Low engagement expected.”

Accordingly, in Step 306, when a message's prediction score equals to or exceeds a predefined threshold, it is considered highly likely to interest the user, which triggers specific handling protocols (see e.g. Steps 308, 310 and 320, discussed infra).). Conversely, scores falling below the threshold prompt additional classification procedures to ensure optimal email management (see e.g. Steps 312-320, discussed infra).

In Step 308, high-priority messages are strategically delivered to the Priority Inbox tab, ensuring immediate user visibility. This delivery mechanism involves sophisticated routing techniques, including placement in a designated “Priority” tab with visual markers like color-coded labels and enhanced presentation formatting. In some embodiments, engine 200 can apply additional attention-grabbing techniques such as, but not limited to, bold subject lines, highlighted icons, customized notifications based on individual user settings, and the like.

In Step 310, engine 200 can perform training operations for the model utilized in Step 306. Step 310 represents a critical feedback loop where the model(s) continuously refines itself based on subsequent user interactions. By meticulously tracking user actions—whether opening, replying, deleting, or moving messages—and measuring engagement metrics like reading time and link interactions, the system dynamically adjusts its prioritization logic. Positive user actions reinforce existing prediction models, while negative interactions trigger recalibration to minimize future false positives.

Turning back to Step 306, for messages with low predicted engagement, processing can proceed to Step 312, where engine 200 initiates a secondary analysis process. In some embodiments, as discussed above, such secondary analysis can be performed by a model(s) on the network and/or on the recipient's device (which can reduce latency and enhance user privacy).

In some embodiments, such analysis can involve deploying an additional classification model that processes messages using updated algorithms and localized user data. Such classification modelling can be any of the AI, ML and/or LLM models discussed above. In some embodiments, engine 200 can augment its analysis by incorporating additional features like, for example, sender domain reputation and message structural characteristics, and employ behavioral clustering to identify engagement patterns shared with similar users, which can be performed in a similar manner as discussed above.

In Step 314, based on the analysis in Step 312, engine 200 can determine and assign messages to specific categories, which can be tied to the manner the message is delivered (e.g., tagged, highlighted, and the like, as discussed supra) and/or a section/portion of an inbox the message is sent to (e.g., categorical tabs such as Promotions, Updates, Social, and Newsletters, for example). Such classifications are resultant from engine 200's complex matching processes that compare message features against predefined rules and dynamically evolving user preferences.

In Step 316, engine 200 can execute delivery mechanisms to ensure optimal inbox organization by strategically placing messages into appropriate portions and/or tabs, considering both framework-defined and user-created custom categories. Visual indicators like tags, icons, and headers can be utilized to enable easy message navigation and identification.

In Step 318, similar to Step 310, engine 200 can perform iterative learning processes for the applied model(s) from Step 312 by tracking user interactions such as tab movements and engagement levels to continuously refine the classification model. This adaptive approach allows engine 200 to respond to changing user behaviors and preferences in real-time.

And, in Step 320, engine 200 can enable interaction and/or customization operations in relation to the message and/or the inbox. For example, users are provided capabilities to, for example, add, rename, or remove tabs, and the like. Users can also be provided functionality for moving a message from a specific tab/section (e.g., move a message from the inbox into a priority tab). Accordingly, engine 200 can provide capabilities for users to perform on-device personalization that captures short-term behavioral changes, and overrides classifications through direct tagging of messages or content categories. Such features collectively create a highly intuitive and personalized email management experience that adapts to individual user needs.

Accordingly, Process 300 showcases the technical sophistication of engine 200's operations in delivering a personalized priority inbox framework. By combining robust AI/ML capabilities, real-time feedback loops and user-centric customization, the framework ensures highly accurate and adaptive email classification. Each step contributes to minimizing the risk of missing important messages, improving user satisfaction, and maintaining a clutter-free inbox. As models continue to evolve through training, the disclosed framework promises to deliver unparalleled personalization and efficiency in email management.

FIG. 6 is a schematic diagram illustrating a client device showing an example embodiment of a client device that can be used within the present disclosure. Client device 600 can include many more or less components than those shown in FIG. 6. However, the components shown are sufficient to disclose an illustrative embodiment for implementing the present disclosure. Client device 600 can represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 can optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 can be a liquid crystal display (LCD), gas plasma, light emitting diode (LED), or any other type of display used with a computing device. Display 654 can also include a touch sensitive screen arranged to receive input from an object such as a stylus or a digit from a human hand.

Keypad 656 can include any input device arranged to receive input from a user. Illuminator 658 can provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 can through other components, provide other information that can be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores can be employed to store information that describes various capabilities of Client device 600. The information can then be provided to another device based on any of a variety of events, including being sent as part of a header (e.g., index file of the HLS stream) during a communication, sent upon request, or the like. At least a portion of the capability information can also be stored on a disk drive or other storage medium (not shown) within Client device 600.

Applications 642 can include computer executable instructions which, when executed by Client device 600, transmit, receive, and/or otherwise process audio, video, images, and enable telecommunication with a server and/or another user of another client device. Applications 642 can further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements can include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors can be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors can be dual-core processor(s), dual-core mobile processor(s), and so forth.

Computer-related systems, computer systems, and systems, as used herein, include any combination of hardware and software. Examples of software can include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements can vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module can be stored on a computer readable medium for execution by a processor. Modules can be integral to one or more servers, or be loaded and executed by one or more servers. One or more modules can be grouped into an engine or an application.

One or more aspects of at least one embodiment can be implemented by representative instructions stored on a machine-readable medium which represents various logic within the processor, which when read by a machine causes the machine to fabricate logic to perform the techniques described herein. Such representations, known as “IP cores,” can be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure can be downloadable from a network, for example, a website, as a stand-alone product or as an add-in package for installation in an existing software application. For example, exemplary software specifically programmed in accordance with one or more principles of the present disclosure can also be available as a client-server software application, or as a web-enabled software application. For example, exemplary software specifically programmed in accordance with one or more principles of the present disclosure can also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure can be implemented in many manners and as such are not to be limited by the foregoing exemplary embodiments and examples. In other words, functional elements being performed by single or multiple components, in various combinations of hardware and software or firmware, and individual functions, can be distributed among software applications at either the client level or server level or both. In this regard, any number of the features of the different embodiments described herein can be combined into single or multiple embodiments, and alternate embodiments having fewer than, or more than, all of the features described herein are possible.

Functionality can also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that can be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications can be made to the elements and operations described above to obtain a result that remains within the scope of the systems and processes described in this disclosure.

What is claimed is:

1. A method comprising:
identifying, by an application, a message addressed to a user;
analyzing, by the application, the message;
determining, by the application, an action prediction by the user upon delivery of the message to an inbox, the action prediction being a type of interaction the user is predicted to perform on the message; and
causing delivery, by the application, of the message based on the determined action prediction, the caused delivery comprising causing the message to be routed to a specific portion of the inbox.

2. The method of claim 1, the action prediction determination comprising:
determining a score for the message based on the analysis; and
comparing the score against a threshold, such that a priority determination for the message is based on the score satisfying the threshold.

3. The method of claim 1, further comprising the analysis of the message involving processing selected from a group consisting of: feature engineering, behavior analysis and contextual analysis.

4. The method of claim 1, further comprising the type of interaction being user engagement with the message, the caused delivery being a priority tab of the inbox.

5. The method of claim 1, further comprising:
further analyzing the message based on the action prediction determination;
determining a classification for the message; and
performing the delivery of the message based further on the classification.

6. The method of claim 1, further comprising the further analysis being performed by another application.

7. The method of claim 1, further comprising enabling modifications to the caused delivery upon completion of the delivery to enable modification of the classification.

8. The method of claim 1, further comprising the application comprising functionality related to an artificial intelligence (AI) model, such that the AI model is trained based on information related to the caused delivery.

9. The method of claim 1, further comprising the application being associated with a mail application executed by a user device.

10. The method of claim 1, further comprising the application being executed by a network device that is an intermediary between the user and a sender of the message.

11. A device comprising:
a processor configured to:
identify, by an application, a message addressed to a user;
analyze, by the application, the message;
determine, by the application, an action prediction by the user upon delivery of the message to an inbox, the action prediction being a type of interaction the user is predicted to perform on the message; and
cause delivery, by the application, of the message based on the determined action prediction, the caused delivery comprising causing the message to be routed to a specific portion of the inbox.

12. The device of claim 11, wherein the processor is further configured to:
determine a score for the message based on the analysis; and
compare the score against a threshold, such that a priority determination for the message is based on the score satisfying the threshold.

13. The device of claim 11, wherein the processor is further configured such that the analysis of the message involves processing selected from a group consisting of: feature engineering, behavior analysis and contextual analysis.

14. The device of claim 11, wherein the processor is further configured such that the type of interaction is user engagement with the message, the caused delivery being a priority tab of the inbox.

15. The device of claim 11, wherein the processor is further configured to:
further analyze the message based on the action prediction determination;
determine a classification for the message; and
perform the delivery of the message based further on the classification.

16. A non-transitory computer-readable storage medium tangibly encoded with computer-executable instructions that when executed by a processor, perform a method comprising:
identifying, by an application, a message addressed to a user;
analyzing, by the application, the message;
determining, by the application, an action prediction by the user upon delivery of the message to an inbox, the action prediction being a type of interaction the user is predicted to perform on the message; and
causing delivery, by the application, of the message based on the determined action prediction, the caused delivery comprising causing the message to be routed to a specific portion of the inbox.

17. The non-transitory computer-readable storage medium of claim 16, the action prediction determination comprising:
determining a score for the message based on the analysis; and
comparing the score against a threshold, such that a priority determination for the message is based on the score satisfying the threshold.

18. The non-transitory computer-readable storage medium of claim 16, further comprising the analysis of the message involving processing selected from a group consisting of: feature engineering, behavior analysis and contextual analysis.

19. The non-transitory computer-readable storage medium of claim 16, further comprising the type of interaction being user engagement with the message, the caused delivery being a priority tab of the inbox.

20. The non-transitory computer-readable storage medium of claim 16, further comprising:
further analyzing the message based on the action prediction determination;
determining a classification for the message; and
performing the delivery of the message based further on the classification.
